(19) United States
(12) Patent Application Publication
(10) Pub. No.: US 2002/0091723 A1
(43) Pub. Date: Jul. 11, 2002

(54) System and method for collection, conversion and presentation of sports data

(75) Inventors: Charles M. Traner, Arlington, TX (US); Timothy M. Kelly, Arlington, TX (US)

Correspondence Address: Brian W. Oaks, Baker Botts L. L. P., 2001 Ross Avenue, Dallas, TX, 75201, US

(73) Assignee: TalkNSports Enterprises

(21) Appl. No.: 09/759,038

(22) Filed: Jan. 10, 2001

(51) Int. Cl. G06F 12/00

(52) U.S. Cl. 707/205

(57) ABSTRACT

A system for collecting, converting, and presenting sports data includes a data collection module that receives information relating to a sporting event from a user of the system and that communicates the information as raw data. The system further includes a data conversion module that receives the raw data from the data collection module and that converts the raw data to formatted data for presentation to one or more users of the system. The formatted data includes text describing the action occurring during the sporting event.

### TECHNICAL FIELD OF THE INVENTION

This invention relates generally to the field of sports, and more specifically to a system and method for collection, conversion and presentation of sports data.

### BACKGROUND OF THE INVENTION

Sporting events, such as baseball and football, are popular pastimes and typically draw crowds at all levels of play—from the friends and family of little league players to the “die-hard” fans of college and professional sporting events. Furthermore, the explosive growth of the World Wide Web (the “web”) has provided fans of sporting events with unprecedented access to information about their favorite sporting events. For example, the web allows fans to track the scores of various sporting events and to “watch” the game by viewing a graphical representation of the progress of the game, such as a football icon moving across a graphic of a football field. In addition, the audio from games that are being broadcast over television or the radio can also be listened to over the web.

Many of these features are only provided when a crew of specialists are attending a particular sporting event. For example, the typical college or professional sporting event has tens or even hundreds of people that assist in the broadcast of the game over television or radio, the calling of the game (including “play-by-play” and commentary), the collection of information about the event for use in writing articles about the event, the creation and formatting of data regarding the sporting event for presentation on the web, and other related tasks. However, many sporting events, especially those at lower levels such as little league and even high school, do not have the support staff to call the game, produce formatted data for presentation on the web, and provide other related services.

### SUMMARY OF THE INVENTION

In accordance with the present invention, a system and method for collection, conversion and presentation of sports data is provided that substantially eliminates or reduces disadvantages or problems associated with previously developed systems and methods.

In one embodiment of the present invention, a system for collecting, converting, and presenting sports data includes a data collection module that receives information relating to a sporting event from a user of the system and that communicates the information as raw data. The system further includes a data conversion module that receives the raw data from the data collection module and that converts the raw data to formatted data for presentation to one or more users of the system. The formatted data includes text describing the action occurring during the sporting event.

Technical advantages of the present invention include a system and method for collection, conversion and presentation of sports data that reduce the effort and number of people needed to report on and present data about a sporting event. For example, a single person may attend or otherwise watch or listen to a sporting event and record the activity taking place during the event. This record of activity, such as a record of the results of each pitch of a baseball game or each play of a football game, is saved as raw data. The raw data may then be automatically converted to text representing a “play-by-play” calling of the event, statistics relating to the event, and/or any other types of appropriate formatted data. The formatted data may then be automatically presented to users over the Internet or at other locations. The users may then listen to the play-by-play using a text-to-speech conversion engine and view statistics relating to the game.

Therefore, play-by-play, statistics, and other formatted data are made available to users by an automated process that requires minimal human intervention. Unlike the typical sporting event for which play-by-play and detailed statistics are available, the present invention does not require a team of specialists to produce this content. Instead, a single person may record raw data relating to the sporting event using the present invention and the raw data may be automatically converted and presented to users in an appropriate format. Such an automated system is particularly useful at sporting events, such a youth sporting events, that may not generate enough revenue to warrant a team of specialists to call, report on, and otherwise produce information about the sporting event. However, such sporting events may generate enough revenue or local interest to provide advertisement-based and other monetary support for the collection, conversion and presentation of sports data using the present invention. Other technical advantages are readily apparent to one skilled in the art from the following figures, descriptions, and claims.

### BRIEF DESCRIPTION OF THE DRAWINGS

For a more complete understanding of the present invention, and for further features and advantages, reference is now made to the following description, taken in conjunction with the accompanying drawings, in which:

FIG. 1 illustrates an exemplary system for the collection, conversion and presentation of sports data;

FIG. 2 illustrates an exemplary graphical user interface of exemplary baseball scoring software;

FIG. 3 illustrates an exemplary method for converting raw data to play-by-play text; and

FIG. 4 illustrates an exemplary method of collecting, converting, and presenting sports data to users.

### DETAILED DESCRIPTION OF THE INVENTION

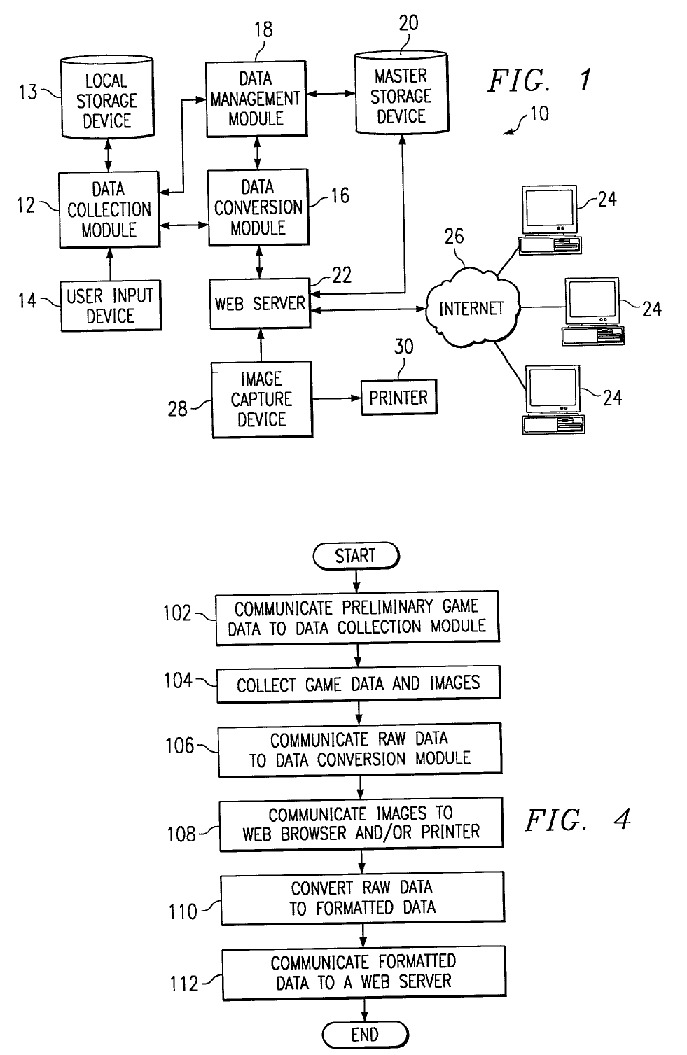

FIG. 1 illustrates an exemplary system 10 for the collection, conversion and presentation of sports data. System 10 includes a data collection module 12 that is used to collect game data at sporting events using a user input device 14, a data conversion module 16 that converts and formats the collected data for presentation to users, and a data management module 18 that manages data relating to sporting events and that stores the data in a master storage device 20. Furthermore, system 10 includes a web server 22 that receives formatted game data from data conversion module 16, storage device 20, and/or any other appropriate sources and communicates the formatted data over the Internet 26 or other appropriate communication networks to one or more users 24. System 10 may also include an image capture device 28 that captures images associated with a sporting event and that communicates the images to a printer 30, web server 22, or any other suitable destination.

The components described above may each be implemented as any appropriate combination of hardware and/or software (the software embodied in a computer-readable medium) operating in one or more locations. The components may operate as part of or in conjunction with one or more computers or other suitable processing devices and the components may communicate with one another using any appropriate inter-process, wireline, or wireless communication links. As an example only and not by way of limitation, data collection module 12 may be embodied as software executing on a mobile computing device (such as a laptop computer, a personal digital assistant (PDA), or a mobile telephone) and data conversion module 16, data management module 18, and web server 22 may be embodied as software executing on another computing device (to which to sports data is communicated from data collection module 12).

Data collection module 12, in conjunction with user input device 14, is used to collect raw data relating to a sporting event. Although data collection module 12 may typically be taken to the sporting event to collect the data, data may also be collected from a television or radio broadcast of the sporting event or in any other appropriate manner. As described above, data collection module 12 may be embodied as software executing on a mobile computing device. Such use of a mobile computing device allows for data collection module 12 to be transported to the sporting event to enable the collection of raw data at the sporting event.

In an exemplary embodiment, data collection module 12 includes sports scoring software, such as baseball or football scoring software. The scoring software allows a user to enter information about the progress of the game and to create a record of what happened during the game. For example, if the sporting event is a baseball game, the scoring software may be used to record the results of each pitch during the game (for example, a ball, strike, walk or hit). If the sporting event is a football game, the scoring software may be used to record the result of each play during the game (for example, the type of play run and the yardage gained or loss). The scoring software may alternatively be used to record the results of any other type of sporting event.

The scoring software may include one or more user interfaces through which a user enters game information using user input device 14. These user interfaces may allow the user to input information graphically using a mouse, trackball, or other suitable user input device 14. Alternatively, the game information may be input textually or using any other appropriate technique.

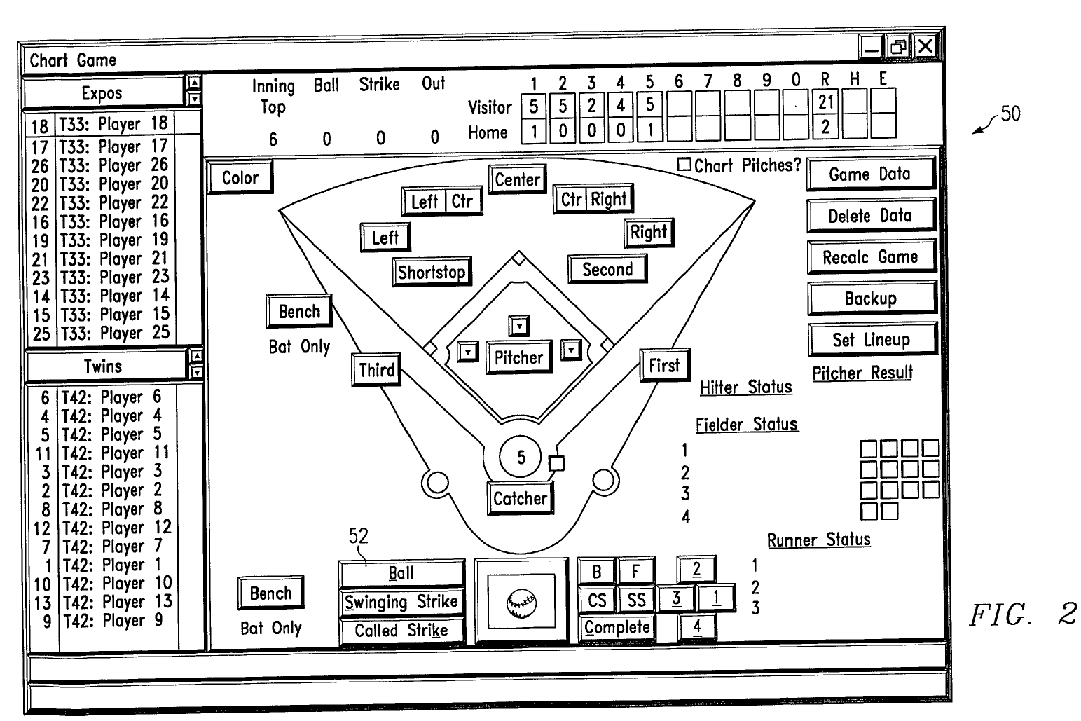

FIG. 2 illustrates an exemplary graphical user interface (GUI) 50 of exemplary baseball scoring software. Interface 50 allows a user to graphically input game information using a “point and click” technique. For example, the user may move a mouse or other input device 14 to move a cursor within interface 50 and to select an object in interface 50 by “pointing” to the object with the cursor and selecting the object by activating a button of the mouse or other input device 14. For example, if a pitcher throws a “ball,” the user can select a ball button 52 to record this action. Alternatively, if a batter “flys out” to center field, the user can record this action by selecting a pitch button 54. Pitch button 54 may initiate another window that provides a detailed set of buttons for the selection of the pitch result (such as a single, double, foul ball, strike, or other appropriate results). As will be understood by one skilled in the art, numerous other actions may be recorded using interface 50. Furthermore, one skilled in the art will understand how to develop and use scoring software to record any appropriate actions that occur during any suitable sporting events.

To enhance the use of data collection module 12, data management module 18 may communicate various types of preliminary game data to data collection module 12 before or during the data collection process. For example, data management module 18 may communicate the names of the teams participating in the sporting event, the rosters of the teams, the batting order or starting lineups, the game time and location, and/or any other appropriate information. This information may be stored by data management module 18 in master storage device 20. Master storage device 20 may include a hard drive, floppy drive, optical storage drive, memory chip(s), or any other appropriate device for storing data on a temporary or permanent basis. When communicated to data collection module 12, this information can be used by data collection module 12 to set up the scoring interface(s) used to collect game data. For example, the batting order, including the name, number, and positions of the players, can be used by interface 50 to automatically select or to allow a user to select a player that is up to bat or a player that is playing a certain position. This name and/or number information may then be associated with an action or actions performed by that player during the game.

When data collection module 12 collects raw data about a particular sporting event, data collection module 12 may save this raw data in a local storage device 13. Local storage device 13 may include a hard drive, floppy drive, optical storage drive, memory chip(s), or any other appropriate device for storing data on a temporary or permanent basis. Alternatively, if data collection module is co-located with data management module 18 and/or master storage device 20, the data may be saved in master storage device 20. The raw data may be saved in any suitable format. For example, raw data may be saved on a “per play” basis as a series of actions that were performed and possibly the associated players that performed the actions. The data may be stored as or associated with keywords that are used to associate the action occurring during a particular play with a phrase or phrases that describe the play. These phrases may then be used to create a play-by-play calling of the game, as described below.

In addition to the collection of raw data by data collection module 12, system 10 also provides for the capturing of game images using an image capture device 28, such as a digital camera. Image capture device 28 may be used to take still images (for example, digital pictures) or moving images (for example, digital video) of players or other activities or objects associated with a sporting event. The captured images may be communicated to web server 22 for display on a web site hosted by web server 22 or the images may communicated to printer 30 for printing. For example, the images may be printed along with advertisements of selected businesses and given to the players or fans. Information about the game and/or a player may also be printed with the image. For example, an image of a player making a play may be captured and printed along with a caption identifying the player and the play being made in the image (the caption may be formatted data obtained from data conversion module 16, as described below). Images captured by image capture device 28 may alternatively be used for any other suitable purpose.

The format in which data collection module 12 stores raw data may not be suitable for presentation to users, such as Internet users 24. Therefore, the raw data may be communicated to data conversion module 16, which converts the raw data into formatted data that may be presented to users. Data collection module 12 may communicate raw data to data conversion module 16 on a per play basis (for example, after every pitch or other action in a baseball game or after every play in a football game), on a per game basis, at specified time intervals, or in any other suitable manner. Data collection module 12 may be located with or separately from data conversion module 16. If located separately from each other, data collection module 12 may communicate the raw data to data conversion module 16 using any appropriate wireline or wireless communication technique.

Data conversion module 16 may convert the raw data into any appropriate format. For example, data conversion module 16 may convert the raw data in a variety of tables, charts or graphs identifying numerous types of statistics relating to a sporting event. For instance, data conversion module 16 may create a table identifying the result of a baseball player's batting attempts or a football player's passing attempts. Data conversion module 16 may also generate other statistics based on the raw data such as a batting average or a pass completion percentage. Alternatively or additionally, data conversion module 16 may communicate formatted data, such as pass completion percentage, to data management module 18 for combination with past game data or other data from the current game. For example, data management module 18 may calculate a quarterback's passing efficiency based on the quarterback's passing attempts in all of the games that have been played in a season or a team's standing in a league based on the results of the games that have been played. It will be understood by one skilled in the art that numerous other types of statistics and related information may be generated from the raw game data. Data management module may store the statistics and other formatted data produced by data conversion module 16 and/or data management system in master storage device 20.

In addition or instead of generating the statistical information described above, data conversion module 16 may convert the raw data associated with a particular play into text describing the action that occurred during the play. This text may be in the form of a “play-by-play” calling of the game or other text that describes the action occurring during the sporting event. For instance, if exemplary raw data indicated that player John Smith hit a fastball to centerfield and that the centerfielder, Jeff Clark, caught the ball for an out, then data conversion module 16 may create the following exemplary text: “Here's the pitch. John Smith hits the fastball long to centerfield. Jeff Clark is under it . . . and he makes the catch for the first out of the inning.” It will be understood that numerous other variations may be created using the exemplary raw data and that numerous other types of raw data may used to create text associated with each play.

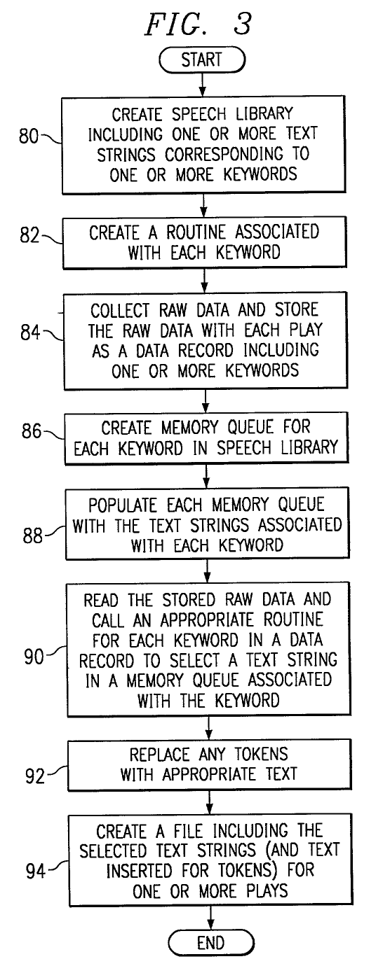

FIG. 3 illustrates an exemplary method for converting raw data to play-by-play text. Although a particular method is described, any other appropriate technique may be used and is included within the scope of the present invention. In an exemplary embodiment, a speech library is created at step 80 that consists of one or more text strings that are associated with one or more keywords in the database. Each keyword is associated with an action that might occur during a sporting event. For example, if the event is a baseball game, a keyword might refer to a hit single. The speech library may contain multiple entries for the hit single keyword, such as “That's a hit” and “He drove that one for a single”.

At step 82, a routine is created for each keyword. For example, for a baseball game there are routines to call the first batter to the plate, to call the next batter to the plate, for the pitcher to get ready to pitch, to call the score of the game, to call a hit single, double, triple or home run, to call a strikeout, fly out, and for any other appropriate actions. There will typically be an extensive set of routines to cover all actions that may occur during the relevant sporting event.

As described above, the raw data for a particular play, pitch, or other occurrence is stored as or associated with a one or more keywords at step 84. At the initialization of the data conversion procedure (which may be on a per game basis, a per play basis, or at any other appropriate intervals), a memory queue is created for each possible keyword at step 86. At step 88, each queue is populated with the speech strings associated with the keyword in the speech library. A default entry may be created if there are no corresponding text strings in the speech library.

At step 90, the stored raw data is read sequentially and a routine is called for each keyword. As described above, the raw data may be created and read every play or at other appropriate intervals. As each data record is read and the action is determined based on the associated keyword, the appropriate routine is called to select a text string from the memory queue associated with the keyword. This selection from the memory queue may be made randomly from multiple text strings in the queue. Therefore, random and varied play-by-play text may be created if multiple text strings are associated with a keyword.

Replacement tokens may also be included in the text strings. The tokens are used to indicate where data related to an action is to be inserted into a text string selected by a routine. After the text string is selected, the ‘token’ may be replaced at step 92 with appropriate text to customize the text string. For example, a token may be included in a string as a “placeholder” for the name of a player and the token may be replaced with the name of a player that performed the action described by the text string. For instance, the text string “TOKEN hits one to left field” may be converted to “Smith hits one to left field.”

At step 94, a file is created that includes the selected text string (including any replaced tokens) for one or more plays or other actions during a sporting event. For example, the file may include a text string associated with a single play or it may include text strings representing a play-by-play calling of an entire sporting event. Furthermore, in a particular embodiment, the text strings are converted to synthesized speech using a text-to-speech conversion engine and then communicated to data management module 18 and/or web server 22 (as described below). In another embodiment, the text strings are communicated to data management module 18 and/or web server 22 without being converted to synthesized speech.

When the formatted data (such as statistics or play-by-play text or audio) has been created from the raw data, the formatted data may be communicated to data management module 18 for storage by master storage device 20 and/or to web server 22 for communication over Internet 26 to users 24. For example, statistical data may be communicated to data management module 18 for use in compiling statistics about a team's or a player's performance or other relevant factors. Data management module 18 may also receive raw data directly from data collection module 12 for use in compiling statistics. Formatted data in the form of play-by-play text or audio files may be communicated directly to web server 22. Furthermore, play-by-play text or audio and/or other types of formatted data may be stored in master storage device 20 in the form of or associated with Hypertext Markup Language (HTML) files or other file formats appropriate for display using a web browser.

Web server 22 may be used to host a number of web pages included in one or more web sites. One or more of the web pages may include information originating from data collection module 12, data conversion module 16, and/or data management module 18. Web server 22 may host web pages associated with a number of different sports, with a number of different leagues in each sport, and with a number of different teams in each league. For example, web server may be used to host a web site that provides information about a number of different little league baseball leagues and the teams in those leagues. Such a web site may contain web pages through which a user 24 can choose a particular league of interest. If a number of leagues are accessible from the web site, the leagues may be organized based on the city and/or state where the league is located. Information that may be available about the league may include the team standings in the league (or in one or more divisions of the league, the scores of games, other statistics relating to the teams, players, and/or games that have been or are being played, play-by-play text or audio of selected games, and any other appropriate information. Similar web pages and information may be provided for other types of sporting events and for other levels of play (for example, junior high school, high school, college, and professional sporting events).

As described above, data collection module 12 may communicate the collected raw data to data conversion module 16 on a play-by-play basis, on a per game basis, at specified time intervals, or in any other suitable manner. Data conversion module 16 may also convert the raw data and communicate the formatted data (such as play-by-play text or audio) to web server 22 and/or data management module 18 on a play-by-play basis, on a per game basis, at specified time intervals, or in any other suitable manner.

In an exemplary embodiment, raw data is converted to play-by-play text or audio after every play, pitch or similar occurrence in a game. The play-by-play text or audio may then be communicated to web server 22 after it is converted. If any of data collection module 12, data conversion module 16, or web server 22 are located on different computers in different locations then the raw data and/or formatted data may be communicated between the appropriate modules 12, 16 and/or web server 22 using any appropriate wireline or wireless technology. As an example only and not by way of limitation, data collection module 12 and data conversion module 16 may both be embodied as software executing on a laptop, PDA, or other mobile computing device. This mobile computing device may be transported to a sporting event and used to collect raw data and convert the raw data to play-by-play text or audio. The play-by-play text or audio may then by communicated to web server 22 or a storage device associated with web server 22 (such as storage device 20) after each play or other action using a wireless modem or other wireless communication device.

The play-by-play text or audio may be presented to users 24 in numerous ways. Play-by-play text associated with a sporting event may be displayed to users 24 in text form as it is communicated to web server 22. For example, the text associated with a play may be displayed on a near real-time basis (although there may be conversion and/or communication delays) or the play-by-play text of an entire game or portions of a game may be displayed to users 24 after the game or portion of the game has been completed. Furthermore, the play-by-play text may be converted to audio using a text-to-speech engine so that users 24 may listen to the play-by-play. As described above, data conversion module 16 may convert the play-by-play text to an audio file and communicate the audio file to web browser 22. Alternatively, data conversion module 16 may communicate a file including the play-by-play text to web server 22. Web server 22 may then incorporate the text in an HTML or other appropriate file and provide tools to allow the user to listen to the text.

As an example only and not by way of limitation, web server 22 may instruct users 24 to download software that provides web-based text-to-speech capabilities. One example of such software is the SPOTw™ (SPeech-On-The-web) software developed by Software Solutions™; however, any other appropriate software may be used. SPOTw is used in conjunction with a text-to-speech engine, such as Microsoft's Text-to-Speech Engine, to provide text-to-speech capabilities in web pages. To use SPOTw or other related software, the appropriate play-by-play text is included in an HTML file or files and identified as text to be converted to speech using the text-to-speech software. A command or commands in the HTML file initiate the text-to-speech software (which may be a “plug-in” to a web browser) and the text is converted to synthesized speech and played to a user 24 (the user's computer will typically include a sound card and one or more speakers).

Although one particular method of providing text-to-speech capabilities using a web page is described, it should be understood that any other appropriate method of converting play-by-play or related text to synthesized speech for presentation to a user 24 is included within the scope of the present invention. Such techniques may include the use of software previously downloaded by users 24 (as described above), the real-time delivery of software (such as Java applets) used to perform the text-to-speech conversion, server-based text-to-speech conversion with the synthesized speech being streamed or otherwise communicated to users 24, or any other suitable techniques.

FIG. 4 illustrates an exemplary method of collecting, converting, and presenting sports data to users. The exemplary method begins at step 102 with the communication of preliminary game data, such as team rosters and starting line-ups, from data management module 18 to data collection module 12. Alternatively, the preliminary game data may be manually entered using user interface device 14. As described above, the preliminary game data may be used to set up a scoring interface, such as interface 50, used to enter data relating to a sporting event. At step 104, data relating to the sporting event is collected using data collection module 12 and is stored as raw data. In addition, images relating to the sporting event are captured using image capture device 28. The raw data is communicated to data conversion module 16 at step 106 and the images are communicated to printer 30, web server 22, and/or any other appropriate location at step 108. As described above, the images may be printed alone or with advertisements and the images may also be incorporated in a web page or pages relating to the sporting event.

At step 110, conversion module 16 converts the received raw data into formatted data. As described above, this formatted data may be play-by-play text or audio, statistics relating to the game, and/or other appropriate data. The formatted data may then be communicated to web server 22 at step 112 for incorporation into one or more web pages. Web server 22 may then communicate the web pages to users 24 of Internet 26 so that users 24 can obtain the formatted data and other information relating to a sporting event for which data was collected.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the spirit and scope of the appended claims.

What is claimed is:

1. A system for collecting, converting, and presenting sports data, comprising:
a data collection module operable to receive information relating to a sporting event from a user of the system and further operable to communicate the information as raw data; and
a data conversion module operable to receive the raw data from the data collection module and further operable to convert the raw data to formatted data for presentation to one or more users of the system, wherein the formatted data includes text describing an action occurring during the sporting event.

2. The system of claim 1, wherein the data collection module comprises a game scoring interface.

3. The system of claim 1, wherein:
the information relating to the sporting event comprises actions occurring during the sporting event; and
the data collection module is further operable to communicate raw data associated with an action occurring during the sporting event to the data conversion module as the information relating to the action is received from the user.

4. The system of claim 3, wherein the data conversion module is further operable to convert the raw data to formatted data as the raw data is received from the data collection module.

5. The system of claim 4, wherein:
the system further comprises a web server coupled to the Internet and operable to receive the formatted data from the data conversion engine and communicate the formatted data to one or more Internet users; and
the data conversion module is further operable to communicate the formatted data to the web server as the data conversion engine generates the formatted data from the raw data.

6. The system of claim 1, wherein:
the information relating to the sporting event comprises actions occurring during the sporting event;
the raw data associated with an action occurring during the sporting event includes one or more keywords associated with the action; and
converting the raw data to formatted data by the data conversion module comprises selecting a text string associated with the keyword from a speech library.

7. The system of claim 6, wherein:
the text string includes one or more tokens; and
the data conversion module is further operable to replace the one or more tokens with data relating to an action so as to customize the text string for the action.

8. The system of claim 1, wherein the data conversion module is further operable to convert the text describing the action occurring during the sporting event to synthesized speech.

9. The system of claim 1, further comprising a web server coupled to the Internet and operable to receive the formatted data from the data conversion engine and communicate the formatted data to one or more Internet users.

10. The system of claim 9, wherein:
the web server is operable to communicate text describing the action occurring during the sporting event to the Internet users; and
the web server is further operable to initiate the communication of text-to-speech conversion software to the Internet users, the software operable to convert the text communicated from the web server to synthesized speech.

11. The system of claim 10, wherein the web server is further operable to communicate a Hypertext Markup Language (HTML) document to the Internet users that includes the text describing the action, the HTML document directing the text-to-speech conversion software to convert the text to synthesized speech for presentation to the Internet users.

12. The system of claim 1, further comprising a data management module operable to manage data associated with the sporting event and to communicate preliminary data relating to the sporting event to the data collection module, the preliminary data used to configure a scoring interface of the data collection module.

13. The system of claim 1, further comprising an image capture device operable to capture images associated with the sporting event and to communicate the images to a web server or a printer.

14. A method for collecting, converting, and presenting sports data, comprising:
receiving information relating to a sporting event from a user of the system at a data collection module;
communicating the information as raw data to a data conversion module; and
converting the raw data to formatted data for presentation to one or more users of the system, wherein the formatted data includes text describing the action occurring during the sporting event.

15. The method of claim 14, wherein:
the information relating to the sporting event comprises actions occurring during the sporting event; and
the method further comprises communicating the raw data associated with an action occurring during the sporting event to the data conversion module as the information relating to the action is received from the user.

16. The method of claim 15, further comprising converting the raw data associated with the action to formatted data as the raw data is received from the data collection module.

17. The method of claim 16, further comprising communicating the formatted data from the data conversion module to a web server coupled to the Internet as the data conversion engine generates the formatted data from the raw data.

18. The method of claim 14, wherein:
the information relating to the sporting event comprises actions occurring during the sporting event;
the raw data includes one or more keywords associated with an action occurring during the sporting event; and
converting the raw data to formatted data comprises selecting a text string associated with the keyword from a speech library.

19. The method of claim 18, wherein:
the text string includes one or more tokens; and
the method further comprises replacing the one or more tokens with data relating to an action so as to customize the text string for the action.

20. The method of claim 14, further comprising converting the text describing the action occurring during the sporting event synthesized speech.

21. The method of claim 14, further comprising:
communicating the formatted data from the data conversion module to a web server coupled to the Internet; and
communicating the formatted data from the web server to one or more Internet users.

22. The method of claim 21, wherein:
communicating the formatted data from the web server comprises communicating text describing the action occurring during the sporting event to the Internet users; and
the method further comprises initiating the communication of text-to-speech conversion software to the Internet users, the software operable to convert the text communicated from the web server to synthesized speech.

23. The method of claim 22, further comprising communicating, from the web server to the Internet users, a Hypertext Markup Language (HTML) document including the text describing the action occurring during the sporting event, the HTML document directing the text-to-speech conversion software to convert the text to synthesized speech for presentation to the Internet users.

24. The method of claim 14, further comprising:
communicating preliminary data relating to the sporting event to the data collection module; and
configuring a scoring interface of the data collection module using the preliminary data.

25. The method of claim 14, further comprising:
capturing images associated with the sporting event; and
communicating the images to a web server or a printer.

26. Sports data collection, conversion, and presentation software embodied in a computer-readable medium and operable to:
receive information relating to a sporting event from a user of the software;
store the information as raw data; and
convert the raw data to formatted data for presentation to one or more users of the system, wherein the formatted data includes text describing the action occurring during the sporting event.

27. The software of claim 26, wherein:
the information relating to the sporting event comprises actions occurring during the sporting event;
the raw data includes one or more keywords associated with an action occurring during the sporting event; and
converting the raw data to formatted data comprises selecting a text string associated with the keyword from a speech library.

28. The software of claim 27, wherein:
the text string includes one or more tokens; and
the software is further operable to replace the one or more tokens with data relating to an action so as to customize the text string for the action.

29. The software of claim 26, further operable to convert the text describing the action occurring during the sporting event to synthesized speech.

30. The software of claim 26, further operable to communicate the formatted data using the Internet to one or more Internet users.

31. The software of claim 30, wherein:
the formatted data communicated to the Internet users comprises text describing the action occurring during the sporting event; and
the software is further operable to initiate the communication of text-to-speech conversion software to the Internet users, the software operable to convert the text to synthesized speech.

32. The software of claim 31, further operable to communicate to the Internet users a Hypertext Markup Language (HTML) document including the text describing the action occurring during the sporting event, the HTML document directing the text-to-speech conversion software to convert the text to synthesized speech for presentation to the Internet users.

33. A system for collecting, converting, and presenting sports data, comprising:
means for receiving information relating to a sporting event from a user of the system;
means for storing the information as raw data; and
means for converting the raw data to formatted data for presentation to one or more users of the system, wherein the formatted data includes text describing the action occurring during the sporting event.

34. The system of claim 33, further comprising means for converting the text describing the action occurring during the sporting event to synthesized speech.

35. The system of claim 33, further comprising means for communicating the formatted data to one or more Internet users.
